(19) United States
(12) Patent Application Publication
(10) Pub. No.: US 2025/0187154 A1
(43) Pub. Date: Jun. 12, 2025

(54) IMPACT WRENCH

(71) Applicant: Hilti Aktiengesellschaft, Schaan (LI)

(72) Inventors: Tashari TER BRAACK, Zurich (CH); Donald MARGOLIS, El Macero, CA (US)

(21) Appl. No.: 18/838,872

(22) PCT Filed: Feb. 14, 2023
(86) PCT No.: PCT/EP2023/053585

§ 371 Date: Aug. 15, 2024

(30) Foreign Application Priority Data
Feb. 28, 2022 (EP) 22159116.7

(51) Int. Cl. B25B 21/02; B25F 5/00

(52) U.S. Cl. CPC B25B 21/026; B25F 5/006

(57) ABSTRACT

An impact wrench (10) including a rotary impact drive (22), wherein the rotary impact drive (22) has a drive shaft (28) running along a longitudinal axis (L), wherein the rotary impact drive (22) has a striker (30) arranged so as to be movable along the longitudinal axis (L), and an anvil head (32) which can be contacted by the striker (30) in a circumferential direction (U) relative to the longitudinal axis (L). The rotary impact drive (22) has at least one impact damper (40, 42, 44) which is configured to damp an impact of the striker (30) in a longitudinal impact direction (LR) parallel to the longitudinal axis (L), in particular on the anvil head (32). Thus undesired vibrations can be reduced or prevented, so that health risks associated with use of the impact wrench (10) can be reduced.

The invention concerns an impact wrench having a rotary impact drive.

### BACKGROUND

By means of rotary impacts, a rotary impact drive of an impact wrench may develop high torques, for example for tightening or loosening a screw.

### SUMMARY OF THE INVENTION

However, during use of an impact wrench, often relatively strong vibrations occur. Health risks from the associated noise or from vibrations transmitted to the body of the user therefore frequently prevent sustained use of an impact wrench.

It is an object of the present invention to provide an impact wrench, use of which should cause lower health risks.

The present invention provides an impact wrench comprising a rotary impact drive, wherein the rotary impact drive has a drive shaft running along a longitudinal axis, wherein the rotary impact drive has a striker arranged so as to be movable along the longitudinal axis, and an anvil head which can be contacted by the striker in a circumferential direction relative to the longitudinal axis, and wherein the rotary impact drive has at least one impact damper which is configured to damp an impact of the striker in a longitudinal impact direction parallel to the longitudinal axis.

The striker may in particular impact the anvil head. Alternatively or additionally, the striker may also impact the drive shaft or a part of the rotary impact drive connected to the drive shaft and/or the anvil head.

During operation of the impact wrench, the striker may in particular strike the anvil head along the longitudinal axis or also in the circumferential direction.

The impact, in particular repeated impacts, of the striker on the anvil head in the longitudinal direction may cause undesired vibrations. The at least one impact damper may reduce the quantity of or completely prevent these undesired vibrations.

Adverse effects on the health of a user of the impact wrench may thus be minimized or completely avoided thanks to the reduction in or complete prevention of vibrations.

In particular, undesired vibrations may be reduced or fully prevented at source and/or at the time of their potential generation. No additional vibration-damping measures are required. For example, it may be obsolete to mount the rotary impact drive inside a housing of the impact wrench in a vibration-damped fashion on the housing. Alternatively, it is conceivable to provide such vibration decoupling of the rotary impact drive from the housing so as to achieve a further reduction of vibrations which may be transmitted to the housing, in particular a handle of the housing, and/or to the user.

The impact damper may be formed between the striker and the anvil head. It may be situated on an impact surface of the anvil head pointing against the longitudinal impact direction.

It may be very economical to produce an impact damper in such a region. It has also been found that a substantial proportion of undesired vibrations can be prevented.

Alternatively or additionally, the impact damper may be formed between the striker and the drive shaft. If the impact damper is formed between the striker and the drive shaft, the drive shaft may be directly and/or indirectly coupled to the anvil head. Thus a relative movement of the striker relative to the anvil head in the longitudinal impact direction may be dampable or damped.

A further reduction in vibrations can be achieved if a rebound damper is formed between a back side of the striker pointing against the longitudinal impact direction, and a rebound face lying opposite the anvil head against the longitudinal impact direction and limiting a movement of the striker along the longitudinal axis.

The impact damper may comprise a material different from that used to form the anvil head and/or contained in the anvil head.

The at least one impact damper may for example comprise a plastic and/or a latex-containing material, for example a rubber-containing material, in particular rubber. Such materials are available at low cost and can develop adequate damping effect.

The impact damper may be configured to damp the impact non-elastically or at least partially non-elastically. It may for example be configured to absorb at least 50 percent of the kinetic energy released on movement of the striker along the longitudinal axis.

The damping effect may also be determined and/or determinable by varying material parameters of a respective rotary impact drive and/or respective impact wrench. For example, parameters such as peak power of the impact wrench, typical power of the impact wrench, rotation frequency, peak pulse and/or similar may be taken into account in this determination.

The impact damper may also comprise a fluid, in particular an oil- and/or water-containing liquid, a gas, in particular air. Thus for example a pneumatic and/or hydraulic impact damper may be created. The damping effect of the impact damper may be adjustable. For example, the fluid may comprise a substance with adjustable viscosity. The viscosity may for example be adjusted electrically and/or magnetically.

The impact damper may be configured to have speed- and/or acceleration-dependent damping. In particular, it may be configured to have a greater damping effect with growing relative speed between the striker and the drive shaft. Alternatively or additionally, it may be configured to have a stronger damping with growing relative acceleration between the striker and the drive shaft. Alternatively or additionally, it is also conceivable that the impact damper has a variable, in particular adjustable damping effect. It may for example comprise an electro- and/or magneto-rheological fluid. The fluid may be dilatant. In general, the fluid may have a non-Newtonian behaviour.

The impact damper may comprise hydraulics and/or pneumatics.

Further features and advantages of the invention are derived from the following detailed description of exemplary embodiments of the invention, with reference to the figures of the drawing which shows details essential to the invention, and from the claims. The features shown therein are not necessarily to be understood as true to scale and illustrated in such a manner that the special features according to the invention can be made clearly visible. The various features can be implemented individually in their own right or collectively in any combinations in variants of the invention.

Exemplary embodiments of the invention are illustrated in the schematic drawing and explained in more detail in the following description.

### BRIEF DESCRIPTION OF THE DRAWINGS

FIG. 1 shows a partially cut-away view of an impact wrench; and

FIG. 2 shows a sectional view of the rotary impact drive of the impact wrench from FIG. 1.

### DETAILED DESCRIPTION

In order to make it easier to understand the invention, the same reference signs are used in each case for identical or functionally equivalent elements in the following description of the figures.

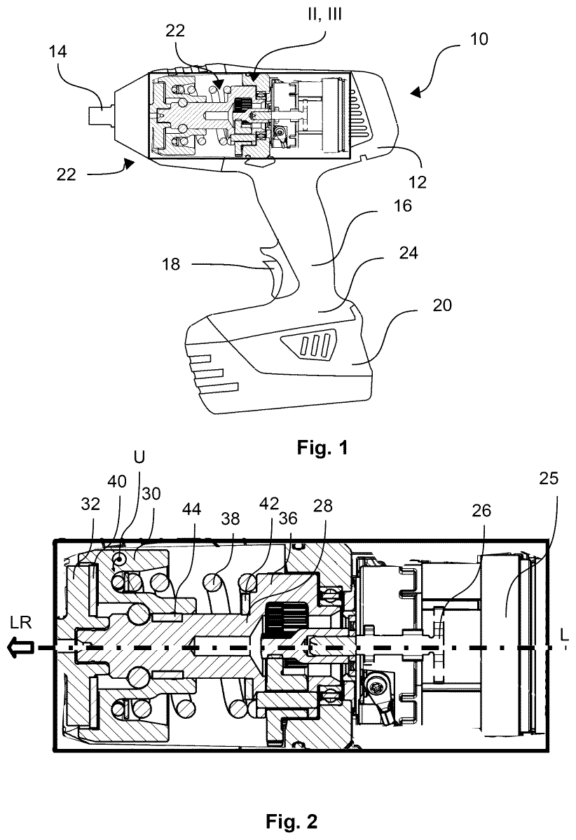

FIG. 1 shows a partly cut-away side view of an impact wrench 10. Firstly, a housing 12 can be seen, from which a tool holder 14 protrudes. A handle region 16 with an operating element 18 is formed on the housing 12. The operating element 18 may be configured for example for switching on and/or off, and/or for regulating an operating parameter of the impact wrench 10, for example a rotation speed.

A rechargeable battery pack 20 serves to supply energy to the impact wrench 10. The battery pack 20 comprises lithium-containing rechargeable batteries. The impact wrench 10 can thus be operated cordlessly. The battery pack 20 may have a capacity of at least 20 Wh. The battery pack 20 may be configured to provide an electrical power of at least 400 W, in particular as peak power, for example for up to 60 seconds, in particular 10 seconds.

The impact wrench 10 furthermore comprises a rotary impact drive 22. The rotary impact drive 22 is arranged inside the housing 12. It is illustrated in a partially cut-away view in region II, III.

The operating element 18, as shown in FIG. 1, may be arranged in a half of the handle region 16 pointing away from the rotary impact drive 22. For this, for example, it may be arranged close to the battery pack 20, for example adjacent to a battery receiver 24 for receiving the battery pack 20. This arrangement of the control element 18 may cause a user of the impact wrench 10 to grip this in a region with little vibration. Thus the load on the user from vibrations may be further reduced.

FIG. 2 shows details of the rotary impact drive 22 in an enlarged illustration of region II, III from FIG. 1.

The rotary impact drive 22 has a motor 25 which drives a drive shaft 28 via a gear mechanism 26, for example a planetary gear mechanism. The drive shaft 28 here defines a longitudinal axis L of the impact wrench 10 (see FIG. 1).

It drives a striker 30 which in turn strikes an anvil head 32 with rotary impacts. In particular, the striker 30 may contact, and in particular strike, the anvil head 32 in a circumferential direction U around the longitudinal axis L. In FIG. 2, the circumferential direction U corresponds to a direction perpendicular to the image plane of FIG. 1 and is therefore depicted merely symbolically in FIG. 2.

The anvil head 32 is connected to the tool holder 14 (see FIG. 1) so that a tool arranged on the tool holder 13 can be driven, in particular with rotary impacts.

The striker 30 is arranged movably along the drive shaft 28 and hence parallel to the longitudinal axis L. On rotation of the drive shaft 28 around the longitudinal axis L, the striker 30 is driven forward in a longitudinal impact direction LR parallel to the longitudinal axis L, in particular in the direction of the anvil head 32 and hence in the direction of the tool holder 14.

A return spring 38 arranged between a back portion 36 of the drive shaft 28 and a back side of the striker 30 is configured to return the striker 30 to a starting position, in particular against the longitudinal impact direction LR, when the drive shaft 28 slows down or stops.

In this embodiment, an impact damper 40 is formed on the anvil head 32. In particular, the impact damper 40 sits between the striker 30 and the anvil head 32. For this, it is arranged on the anvil head 32.

When the impact wrench 10 is brought into operation, for example by means of the operating element 18 (see FIG. 1), the striker 30 is accelerated in the longitudinal impact direction LR.

In particular at high speeds of the striker 30 in the longitudinal direction LR, it may occur that the striker 30 hits the anvil head 32 in the longitudinal direction LR. The impact damper 40 situated in between however damps such impacts or strikes. Thus vibrations resulting from such impacts in the longitudinal impact direction LR can be prevented or at least reduced

The impact damper 40 may comprise a plastic and/or a rubber-containing material, e.g. rubber.

When the striker 30 is repelled by the return spring 38, it may hit the back portion 36 with its back side. To damp such an impact, a rebound damper 42 is formed on the back portion 36. Thus the rotary impact drive 22 comprises a further impact damper in the form of the rebound damper 42, which is configured to damp an impact of the striker 30 in a longitudinal impact direction parallel to the longitudinal axis. The rebound damper 42 also helps reduce or fully prevent undesired vibrations.

The rotary impact drive 22 of the impact wrench 10 furthermore comprises a slide damper 44. The slide damper 44 is formed on the circumference of the drive shaft 28. It comprises a material with a higher sliding friction coefficient than the adjacent drive shaft 28. Thus when the striker 30 reaches the region of the slide damper 44, for example because of a correspondingly high speed in the longitudinal direction LR, the movement of the striker 30 in the longitudinal direction LR is braked because of the increased friction coefficient of the slide damper 44. Thus an impact of the striker 30 in the longitudinal direction LR can be prevented or at least reduced, so that undesired vibrations can thereby be prevented or at least reduced.

The impact damper 40 and/or the rebound damping 42 may comprise a plastic and/or a rubber-containing material, e.g. rubber.

In the embodiment of the impact wrench 10 shown here, the impact damper 40, the rebound damper 42 and the slide damper 44 are configured as passive elements. It is also conceivable that at least one of these elements 40, 42, 44 has at least one adjustable property, e.g. an adjustable damping, a viscosity which can be adjusted for example electrically and/or magnetically, and/or an adjustable coefficient of friction. The element or elements with adjustable property may be connected to a control unit of the impact wrench 10. The control unit may be configured to adjust the adjustable property depending on a position, a speed and/or an acceleration, in particular in the longitudinal direction L.

The embodiment of the impact wrench 10 shown here thus in total has three impact dampers, in particular the impact damper 40, the rebound damper 42 and the slide damper 44. In alternative embodiments, it may be provided that only one two of these impact dampers, or more than three impact dampers are provided.

### LIST OF REFERENCE SIGNS

10 Impact wrench
12 Housing
14 Tool holder
16 Handle region
18 Operating element
20 Rechargeable battery pack
22 Rotary impact drive
24 Receiver
25 Motor
26 Transmission
28 Drive shaft
30 Striker
32 Anvil head
36 Portion
38 Return spring
40 Impact damper
42 Rebound damper
44 Slide damper
II, III Region
L Longitudinal axis
LR Longitudinal impact direction
U Circumferential direction

1-3. (canceled)

4. An impact wrench comprising:
a rotary impact drive having a drive shaft running along a longitudinal axis, a striker arranged so as to be movable along the longitudinal axis, and an anvil head contactable by the striker in a circumferential direction relative to the longitudinal axis,
the rotary impact drive having:
at least one damper configured to damp an impact of the striker in a longitudinal impact direction parallel to the longitudinal axis, wherein
the at least one damper includes a first impact damper formed between the striker and the anvil head, or
the at least one damper includes a second impact damper formed between the striker and the drive shaft, or
the at least one damper includes a rebound damper formed between a back side of the striker pointing against the longitudinal impact direction and a rebound face lying opposite the anvil head against the longitudinal impact direction and limiting a movement of the striker along the longitudinal axis.

5. The impact wrench as recited in claim 4 wherein the impact or rebound damper includes a plastic or a latex-containing material.

6. The impact wrench as recited in claim 5 wherein the latex-containing material is rubber.

7. The impact wrench as recited in claim 4 wherein the impact damper includes a fluid or a gas.

8. The impact wrench as recited in claim 7 wherein the impact damper includes the fluid, the fluid being an oil- or water-containing liquid.

9. The impact wrench as recited in claim 7 wherein the impact damper includes the gas, the gas being air.

10. The impact wrench as recited in claim 4 wherein the at least one impact damper damps an impact on the anvil head.
